(19) United States
(12) Patent Application Publication
(10) Pub. No.: US 2023/0094656 A1
(43) Pub. Date: Mar. 30, 2023

(54) CROSS-LAYER AUTOMATED NETWORK VULNERABILITY IDENTIFICATION AND LOCALIZATION

(71) Applicant: AMITAV MUKHERJEE, ELK GROVE, CA (US)

(72) Inventor: AMITAV MUKHERJEE, ELK GROVE, CA (US)

(21) Appl. No.: 17/954,295

(22) Filed: Sep. 27, 2022

Related U.S. Application Data
(60) Provisional application No. 63/250,113, filed on Sep. 29, 2021.

(51) Int. Cl. H04W 12/121; H04L 9/40

(52) U.S. Cl. CPC H04W 12/121; H04L 63/1433

(57) ABSTRACT

Embodiments herein include an alternative approach to vulnerability detection, denoted as an automated network vulnerability identification and localization application (ANVIL). More specifically, a network includes multiple hardware and software-based entities that communicate with each other over standardized or proprietary protocol interfaces with the objective of providing data, computing capabilities, or voice connectivity to an end user such as a mobile device. For example, a device-based or core network-based instance of ANVIL emulates different protocol layers in order to periodically scan and probe the message responses of different protocol layers and the accessibility of different network interfaces to unauthorized users. Fuzzing message responses are used to generate new fuzzing messages based on machine learning techniques in order to localize potential vulnerabilities. Multiple protocol layers and communication protocols may be emulated and multiple network entities may be probed by a single instance of ANVIL. The responses of the network to the fuzzing messages and port scans are collated by ANVIL and reported to an administrator via a dashboard that highlights potential vulnerabilities in the network and suggested remedies.

This application claims the benefit of an earlier-filed provisional application U.S. 63/250,113.

### BACKGROUND

Fifth-generation (5G) wireless networks are being deployed for a wide range of mobile broadband, tactical, industrial, and logistical communications use cases. Securing 5G radio access and core networks from adversarial threats (denial of service, jamming, spoofing, man-in-the-middle, replay attacks, etc.) across all layers of the protocol stack (radio, data link, network, transport, session, presentation and application layer) is a challenging task due to the use of very wide radio frequency channels, multiple technology vendors, the risk of improper implementation of security features, decentralized network architectures and extensive use of cloud computing principles. Identifying vulnerabilities across the entire attack surface of a 5G network is therefore a necessary first step to securing it against threats.

The state of the art in 5G security is that a mix of standardized and proprietary products are cobbled together in a 5G network, and each solution addresses a certain protocol layer or mobile core functionality. For example, the 5G standards specify authentication and key agreement protocols that utilize a private key stored in the device universal subscriber identity module (USIM). The exact implementation of these protocols is up to a particular operator and the associated network equipment vendors. Individual network equipment vendors may choose to employ various levels of security assurance and protocol fuzzing tests for their products, but these measures are discretionary. Firewalls are deployed for packet inspection and filtering at various endpoints. More specifically for vulnerability detection, network operators employ tools that scan information technology assets (network routers, switches, device operating systems), but only operate at or above the network protocol layer and are not designed specifically for 5G.

Therefore, a single, end-to-end vulnerability detection tool that encompasses all protocol layers of a communication network, including the physical layer, currently does not exist.

### BRIEF DESCRIPTION OF EMBODIMENTS

There are deficiencies associated with conventional techniques of identifying security vulnerabilities in mobile, wireless, and converged wireless-wireline communications networks. For example, commercial solutions for protocol fuzzing—the transmission of intentionally malformed or garbled signaling messages to a network entity—are restricted to a subset of Layer 3 protocols such as NGAP (NG Application Protocol) and XnAP while Layer 2 protocols remain untested. An improperly designed or implemented network entity or network function will not know how to handle unexpected fuzzing messages, will throw an exception and may run out of memory, resulting in an outage and revealing a vulnerability that can be exploited by an adversary.

Embodiments herein include an alternative approach to vulnerability detection, denoted as an automated network vulnerability identification and localization application (ANVIL). More specifically, a network includes multiple hardware and software-based entities that communicate with each other over standardized or proprietary protocol interfaces with the objective of providing data, computing capabilities, or voice connectivity to an end user such as a mobile device. For example, an instance of ANVIL emulates different protocol layers in order to periodically scan and probe the message responses of different protocol layers and the accessibility of different network interfaces to unauthorized users. Fuzzing message responses are used to generate new fuzzing messages based on machine learning techniques in order to localize potential vulnerabilities. Multiple protocol layers and communication protocols may be emulated and multiple network entities may be probed by a single instance of ANVIL. The responses of the network to the fuzzing messages and port scans are collated by ANVIL and reported to an administrator via a dashboard that highlights potential vulnerabilities in the network and suggested remedies.

In one embodiment, an instance of ANVIL is deployed on a mobile device or user equipment (UE). ANVIL generates fuzzing messages targeting the Radio Resource

Control (RRC) protocol in RRC IDLE, RRC INACTIVE, and/or RRC CONNECTED UE states. These messages are periodically transmitted over the air interface to the 5G base station (gNB), which has a peer RRC entity, and the responses are monitored. The same ANVIL instance also transmits and monitors the response to fuzzing of medium access control (MAC) layer messages. ANVIL also attempts to access OAM and network management interfaces on the gNB. ANVIL monitors and fuzzes fronthaul or midhaul transport links between the gNB radio unit and digital unit or gNB digital unit and central unit that utilize protocols such as eCPRI or radio over Ethernet.

In a further example embodiment, the ANVIL instance on the UE collects radio frequency (RF) information in the form of signal strength and signal quality of the serving cell and adjacent cells to assess the vulnerability of the network to RF threats such as jamming, rogue base station attacks, spoofing, and eavesdropping.

In a further example embodiment, the ANVIL software instance is deployed on a 5G mobile core that is hosted on a compute server on-premise or in the public cloud. ANVIL has access to packets being transferred on or more communication protocols between core network functions (NFs) or between the radio access network and the core. ANVIL emulates different communication protocols used for information exchange between NFs and network entities such as routers, firewalls, and switches. The emulation is followed by port scanning and fuzzing procedures to check for potential vulnerabilities in entity configuration and exception handling.

Embodiments herein are useful over conventional techniques. For example, two major advantages of this approach are: i) exploit correlations across protocol layers to enhance the accuracy of vulnerability detection, ii) move beyond the siloed approach to security currently in use. Additional advantageous features include compatibility with any standards-based 5G radio and mobile core (on-premise or cloud) infrastructure in a vendor-agnostic manner, and the provision of a single-pane-of-glass view of all potential threats and elimination of any network security blind spots.

Note that any of the resources as discussed herein can include one or more computerized devices, wireless stations, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to facilitate use of a wireless channel by wireless stations supporting different communication protocols. The instructions, when executed by computer processor hardware, cause the computer processor hardware (such as one or more co-located or disparately processor devices) to: assign wireless bandwidth for use by wireless stations in a wireless network environment to communicate amongst each other; monitor use of the wireless bandwidth; and in response to detecting use of the wireless bandwidth by an entity having higher priority rights than the wireless stations, operate in a shared mode in which the wireless stations and the entity share use of the wireless bandwidth in a control period according to a duty cycle.

The ordering of the steps above has been added for clarity's sake. Note that any of the processing steps as discussed herein can be performed in any suitable order. Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of wireless technology supporting simultaneous use of multiple wireless protocols (such as 5G New Radio and LTE) by multiple network devices. However, it should be noted that embodiments herein are not limited to use in such applications and that the techniques discussed herein are well-suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a user equipment (UE) on which an instance of the cross-layer automated network vulnerability identification and localization (ANVIL) application is installed.

FIG. 2 is an example diagram illustrating a wireless network environment where ANVIL is deployed on a UE to scan and test vulnerabilities at the radio, data link (medium access control and radio resource control) layers and the non-access stratum layer (NAS) according to embodiments herein.

FIG. 3 is an example diagram illustrating a radio access network and mobile core where ANVIL is deployed at both UE and in the core in order to scan and test vulnerabilities on additional network functions and network interfaces.

FIG. 4 is an example diagram illustrating the transmission of multiple protocol fuzzing messages from an instantiation of ANVIL and their corresponding responses from a network function in the mobile core using the HTTP protocol as a non-limiting example.

FIG. 5 is an example diagram illustrating the transmission of multiple port scan messages from an instantiation of ANVIL and their corresponding responses from a network entity according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

In accordance with general embodiments, a system includes network entities and network functions that communicate with each other using packetized messages on standards-based protocol interfaces. An instantiation of ANVIL emulates different protocol layers in order to periodically scan and probe the message responses of different protocol layers and the accessibility of different network interfaces to unauthorized users. Fuzzing message responses are used to generate new fuzzing messages based on machine learning techniques in order to localize potential vulnerabilities. Multiple protocol layers and communication protocols may be emulated and multiple network entities may be probed by a single instance of ANVIL. The responses of the network to the fuzzing messages and port scans are collated by ANVIL and reported to an administrator via a dashboard that highlights potential vulnerabilities in the network and suggested remedies.

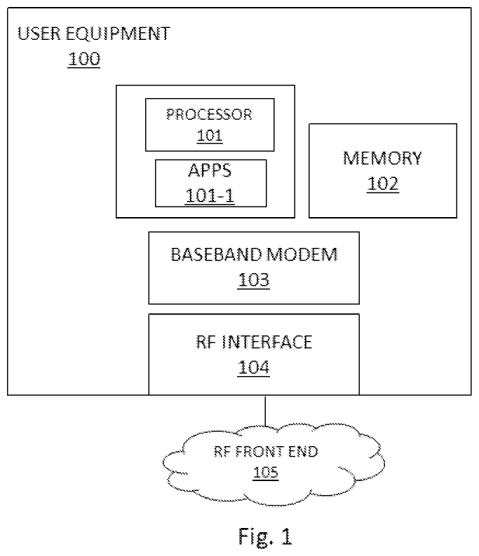

Now, more specifically, FIG. 1 is an example diagram illustrating a user equipment or mobile device and operation of ANVIL in a first mode according to embodiments herein.

As shown in this example embodiment, user equipment (UE) 100 includes a processor 101 that executes software applications 101-1 such as ANVIL, memory 102 for storage, a baseband modem 103 for digital signal processing, a radio frequency (RF) interface 104 that converts analog RF signals to digital for reception and vice versa for transmission, and a RF front end 105 that comprises power amplifiers, local oscillators, and antenna elements for RF transmission and reception.

Note that each of the resources in UE 100 can be configured to include appropriate hardware, software, or combination of hardware and software to carry out respective operations as discussed herein.

For example, an instantiation of ANVIL on UE 100 monitors and measures the RF signal strengths of adjacent base stations and UEs received at the RF front end 105 to assess the vulnerability of the radio layer to jamming and spoofing attacks by adversaries. The results of the assessment are stored in memory 102 and collated as part of a vulnerability assessment report sent to either another instance of ANVIL or to a reporting dashboard.

Those skilled in the art will understand that the UE 100 can include other processes and/or software and hardware components, such as an input/output interface to a display, or an operating system that controls allocation and use of hardware resources to execute application commands 101-1.

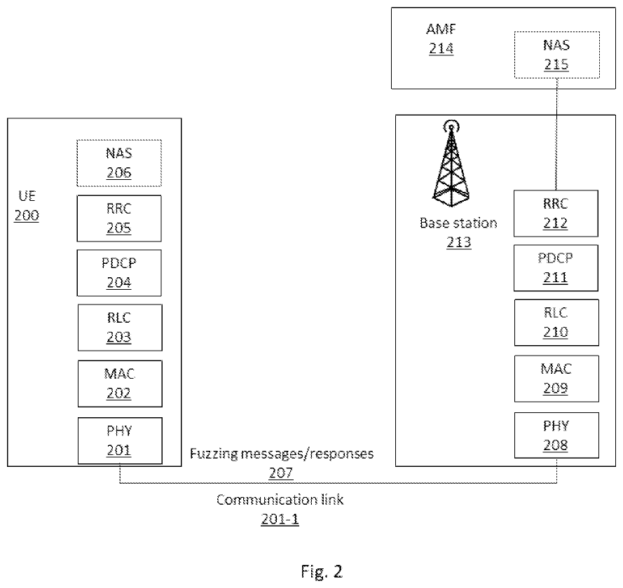

FIG. 2 is an example diagram illustrating a wireless network environment where ANVIL is deployed on a UE 200 with access to the radio or physical layer 201, data link (medium access control 202, radio link control 203, packet data convergence protocol (PDCP) 204 and radio resource control (RRC) 205) layers and the non-access stratum layer 206 (NAS) at the UE. The protocol layers at the UE are used to generate port scan and protocol fuzzing messages 207 directed at the corresponding peer entities at the physical layer 208, data link (medium access control 209, radio link control 210, packet data convergence protocol (PDCP) 211 and radio resource control (RRC) 212 at the base station 213 and NAS layer 214 at the access management function (AMF) 215 in the mobile core. The port scan and fuzzing messages are transmitted over a wireless or wireline communication link 201-1 between the UE and the base station. The corresponding responses from these peer entities are collated by ANVIL to generate a vulnerability assessment for this particular segment of the network environment.

In another example embodiment, a series of message responses 207 are used to generate an updated series of fuzzing messages based on adversarial machine learning methods in order to localize network vulnerabilities.

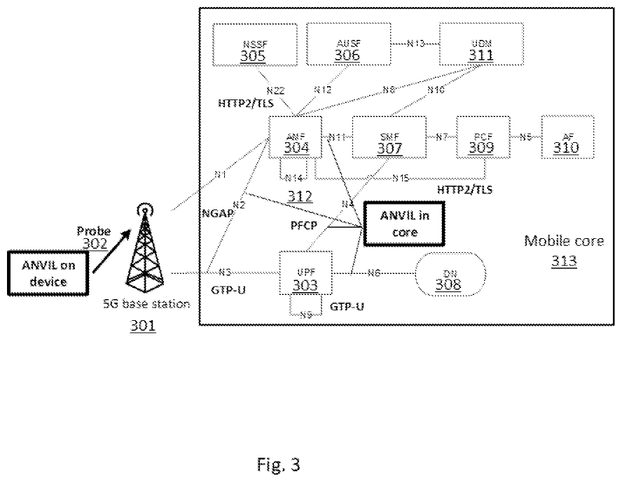

FIG. 3 is an example diagram of a network environment comprising a UE 300, a base station 301, and a mobile core 313 that is hosted in a software environment in a data center or cloud. The mobile core comprises multiple network functions (NFs) that are virtualized or containerized. Example NFs shown herein are the access management function 304 (AMF), session management function 307 (SMF), user plane function 303 (UPF), policy control function 309 (PCF), application function 310 (AF), network slice selection function 305 (NSSF), authentication server function 306 (AUSF), and unified data management 311 (UDM). The UPF is a user plane function that communicates to an external data network 308 (DN). All other NFs are control plane functions. Two instantiations of ANVIL, one at the UE 300 and one in the mobile core 313, are shown. The ANVIL instance on the UE sends probe messages 302 as described in FIG. 2. The ANVIL instance in the mobile core transmits port scan and fuzzing messages 312 over multiple transport protocols (HTTP/2, HTTPS, GTP-U, PFCP) to various NFs and network entities such as firewalls. The responses of the network to the fuzzing messages and port scans are collated by ANVIL and reported to an administrator via a dashboard that highlights potential vulnerabilities in the network and suggested remedies.

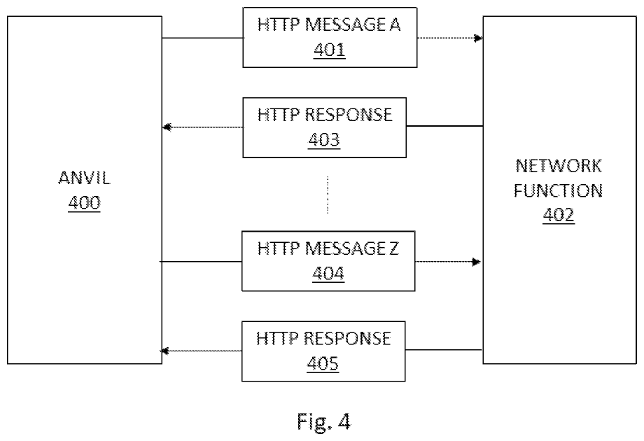

FIG. 4 is a more detailed example diagram of the transmission by an instantiation of ANVIL 400 of a sequence of fuzzing messages starting with message A 401 and ending with message Z 404 using HTTP to a network function 402 in the mobile core. The NF responds with a sequence of message responses using HTTP, starting with response A 402 and ending with response Z 405. It is noted that no response may be sent by the NF 402 to a message from ANVIL 400.

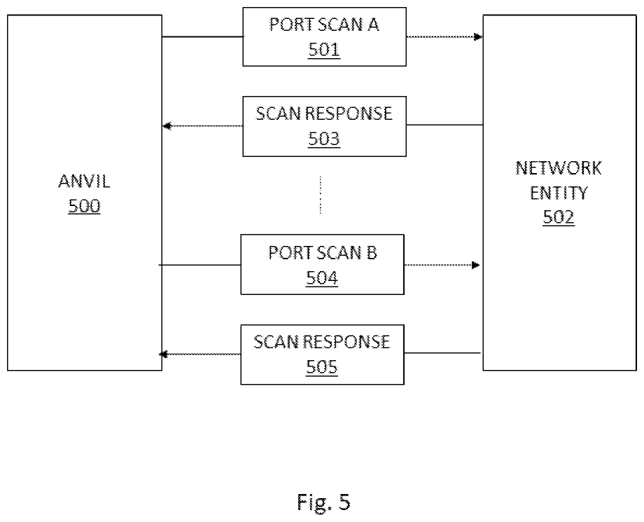

FIG. 5 is a more detailed example diagram of the transmission by an instantiation of ANVIL 500 of a sequence of port scan messages starting with message A 501 and ending with message Z 504 to a network entity 502 in the network environment, such as a router, switch, firewall, or management interface. The entity responds with a sequence of message responses, starting with response A 502 and ending with response Z 505. It is noted that no response may be sent by the entity 502 to a message from ANVIL 500.

Note again that techniques herein are well suited to facilitate automated network vulnerability detection and localization. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
transmitting a sequence of probe messages to one or more entities across multiple protocol layers in a communication network environment;
monitoring responses to these messages; and
in response to detecting anomalous responses, creating a list of potential network vulnerabilities.

2. The method as in claim 1, wherein the probe messages include port scan messages to test unprotected network interfaces and protocol fuzzing messages designed to test exception handling.

3. The method as in claim 1, wherein the multiple protocol layers are specific to a mobile network, such as the physical layer, medium access control, radio link control, packet data convergence protocol, service data adaption protocol, radio resource control, and non-access stratum layer.

4. The method as in claim 1, wherein the sequence and content of probe messages is formulated and updated in real time based on the responses observed to prior probe messages.

5. The method as in claim 1, wherein the network entities include network functions that comprise a mobile core that provides data and voice connectivity to devices.

6. The method as in claim 1, wherein the transmission of probe messages is preceded by a passive monitoring phase that analyzes control, broadcast data, and beacon messages from the communication network.

7. A system comprising:
communication hardware operative to:
transmitting a sequence of probe messages to one or more entities across multiple protocol layers in a communication network environment;
monitoring responses to these messages; and
in response to detecting anomalous responses, creating a list of potential network vulnerabilities.

8. The system as in claim 7, wherein the communication hardware is further operative to include port scan messages to test unprotected network interfaces and protocol fuzzing messages designed to test exception handling.

9. The system as in claim 7, wherein the multiple protocol layers are specific to a mobile network, such as the physical layer, medium access control, radio link control, packet data convergence protocol, service data adaption protocol, radio resource control, and non-access stratum layer.

10. The system as in claim 7, wherein the sequence and content of probe messages is formulated and updated in real time based on the responses observed to prior probe messages.

11. The method as in claim 7, wherein the network entities include network functions that comprise a mobile core that provides data and voice connectivity to devices.

12. The system as in claim 7, wherein the communication hardware is further operative to:
transmission of probe messages preceded by a passive monitoring phase that analyzes control, broadcast data, and beacon messages from the communication network.
